(19) United States
(12) Patent Application Publication
(10) Pub. No.: US 2025/0094149 A1
(43) Pub. Date: Mar. 20, 2025

(54) CLOUD SERVICE DEPLOYMENT METHOD AND APPARATUS, ELECTRONIC DEVICE AND STORAGE MEDIUM

(71) Applicant: Beijing Volcano Engine Technology Co., Ltd., Beijing (CN)

(72) Inventors: Tao YANG, Beijing (CN); Zhenwei PI, Beijing (CN)

(21) Appl. No.: 18/729,493

(22) PCT Filed: May 9, 2023
(86) PCT No.: PCT/CN2023/092903

§ 371 Date: Jul. 16, 2024

(30) Foreign Application Priority Data
May 27, 2022 (CN) 202210587970.0

(51) Int. Cl. G06F 8/60; G06F 9/50

(52) U.S. Cl. CPC G06F 8/60; G06F 9/5044; G06F 9/5083; G06F 2209/5011; G06F 2209/503

(57) ABSTRACT

Provided in the present disclosure are a method for deploying cloud service, electronic device, and storage medium. The method includes: determining available computing resources in a computing resource pool in response to a deploying request for a target cloud service; determining a target computing node with most available computing resources; determining whether the target computing node meets a deploying condition of the target cloud service; when the target computing node does not meet the deploying condition, selecting a standby computing node group from computing node groups other than the target computing node group, and combining the standby computing node group into the target computing node group, and re-determining a target computing node with most available computing resources in the target computing node group; and when the target computing node meets the deploying condition, deploying the target cloud service on the target computing node.

This application claims priority to Chinese Patent Application No. 202210587970.0, filed on May 27, 2022, which is incorporated herein by reference in its entirety as a part of this application.

### TECHNICAL FIELD

Embodiments of the present disclosure relate to a method and apparatus for deploying cloud service, electronic device, and storage medium.

### BACKGROUND

Cloud services are based on add, use, and interactive modes of related services of the Internet. Through the cloud services, a user does not need to independently configure a physical device such as a server, and only needs to deploy a required service on a cloud service platform, and the cloud service platform can allocate computing resources to the deployed service, so that the deployed service can be accessed.

The cloud service platform usually maintains a plurality of computing nodes. These computing nodes have a particular quantity of physical computing resources, used to create a virtual machine that has a corresponding resource quantity according to a requirement of the user, so as to provide a cloud service for the user. In a cloud service deploying process, load degree of a computing node and resource utilization affect each other. To improve the utilization of computing resources, the load degree of the computing nodes increases, resulting in a decrease in running performance. To ensure running performance of the computing node, the load degree of the computing node decreases, the utilization of the computing resources decreases, and it is difficult to balance the load and the resource utilization.

### SUMMARY

Embodiments of the present disclosure at least provides a method and apparatus for deploying cloud service, electronic device, and storage medium.

In a first aspect, an embodiment of the present disclosure provides a method for deploying cloud service, including:
determining available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
determining a target computing node with most available computing resources from a currently used target computing node group in the computing resource pool;
determining, based on a target resource quantity indicated by the deploying request and a quantity of the available computing resources of the target computing node, whether the target computing node meets a deploying condition of the target cloud service;
when the target computing node does not meet the deploying condition, selecting a standby computing node group from computing node groups other than the target computing node group, and combining the standby computing node group into the target computing node group, and re-determining a target computing node with most available computing resources in the target computing node group; and
when the target computing node meets the deploying condition, deploying the target cloud service on the target computing node.

In an optional implementation, the available computing resources in the computing resource pool are divided by the following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

In an optional implementation, the dividing the plurality of available computing nodes into the N computing node groups based on the attribute information and the service requirement information includes:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

In an optional implementation, the dividing the plurality of available computing nodes into the N computing node groups based on the attribute information and the service requirement information includes:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

In an optional implementation, the determining, based on a target resource quantity indicated by the deploying request and a quantity of the available computing resources of the target computing node, whether the target computing node meets a deploying condition of the target cloud service includes:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

In an optional implementation, the selecting a standby computing node group from computing node groups other than the target computing node group, and combining the standby computing node group into the target computing node group includes:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.

In an optional implementation, the deploying the target cloud service on the target computing node includes:
deploying a target virtual machine on the target computing node, wherein available computing resources occupied by the target virtual machine match the target resource quantity; and
deploying the target cloud service on the target virtual machine.

In a second aspect, an embodiment of the present disclosure also provides an apparatus for deploying cloud services, including a first determining module, a second determining module, a third determining module, a fourth determining module and a deploying module,
a first determining module is configured to determine available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
a second determining module is configured to determine a target computing node with most available computing resources from a currently used target computing node group in the computing resource pool;
a third determining module is configured to determine, based on a target resource quantity indicated by the deploying request and a quantity of the available computing resources of the target computing node, whether the target computing node meets a deploying condition of the target cloud service;
a fourth determining module is configured to: when the target computing node does not meet the deploying condition, select a standby computing node group from computing node groups other than the target computing node group, and combine the standby computing node group into the target computing node group, and re-determine a target computing node with most available computing resources in the target computing node group; and
a deploying module is configured to: when the target computing node meets the deploying condition, deploy the target cloud service on the target computing node.

In a third aspect, an embodiment of the present disclosure also provides an electronic device, including: a processor, a memory, and a bus, wherein the memory stores machine-readable instructions executable by the processor, and when the electronic device runs, the processor communicates with the memory via the bus, and the machine-readable instructions, when executed by the processor, perform the steps in the first aspect described above, or in any possible implementation of the first aspect.

In a fourth aspect, an embodiment of the present disclosure also provides a computer-readable storage medium, wherein the computer-readable storage medium stores a computer program, and the computer program, when executed by a processor, performs the steps in the first aspect described above, or in any possible embodiment of the first aspect.

According to the method and apparatus for deploying cloud service, the electronic device, and the storage medium that are provided in embodiments of the present disclosure, first, the available computing resources in the computing resource pool are determined in response to the deploying request for the target cloud service, where the computing resource pool is determined based on the computing resources of the computing nodes in the computing node cluster, and the computing nodes in the computing resource pool are divided into the N computing node groups, N is set based on the service requirement, and the value of N is greater than or equal to 1 and less than or equal to the total number of the computing nodes in the computing node cluster; then the target computing node with the most available computing resources is determined from the currently used target computing node group in the computing resource pool; and then, based on the target resource quantity indicated by the deploying request and the quantity of the available computing resources of the target computing node, whether the target computing node meets the deploying condition of the target cloud service is determined; when the target computing node does not meet the deploying condition, the standby computing node group is selected from computing node groups other than the target computing node group, and the standby computing node group is combined into the target computing node group, and the target computing node with the most available computing resources in the target computing node group is redetermined; or if the target computing node meets the deploying condition, the target cloud service is deployed on the target computing node. In the implementations of the present disclosure, the target computing node group is determined from the plurality of available computing node groups, cloud service deployment is preferentially performed in the target computing node group, and then the standby computing node group is introduced when the deploying condition is not met, so as to effectively reduce the resource fragments of the computing nodes, thereby avoiding waste of the computing resources. In addition, the target computing node with the highest quantity of available computing resources is selected from the target computing node group to deploy the cloud services, to enable the cloud services to be disperse to the greatest extent in the range of the target computing node group, and prevent occurrence of the computing node with excessively high load, thereby ensuring normal running of the computing nodes.

In order to make the foregoing objectives, features and advantages of the present disclosure more obvious and understandable, the following provides detailed descriptions by using preferred embodiments in cooperation with the accompanying drawings.

### BRIEF DESCRIPTION OF DRAWINGS

In order to more clearly describe the technical solutions of embodiments of the present disclosure, the following briefly describes the accompanying drawings to be used in embodiments. The accompanying drawings herein are incorporated in this specification and form a part of this specification, show embodiments consistent with the present disclosure, and are used together with this specification to describe the technical solutions of the present disclosure. It should be understood that the following accompanying drawings show only some embodiments of the present disclosure, and therefore should not be regarded as limiting the scope, and a person of ordinary skill in the art may further obtain other relevant accompanying drawings from these accompanying drawings without creative efforts.

FIG. 1 is a flowchart of a cloud service deploying method according to an embodiment of the present disclosure;

FIG. 2 is a first schematic diagram of attribute information of available computing nodes according to an embodiment of the present disclosure;

FIG. 3 is a second schematic diagram of attribute information of available computing nodes according to an embodiment of the present disclosure;

FIG. 4 is a schematic diagram of another cloud service deploying apparatus according to an embodiment of the present disclosure; and

FIG. 5 is a schematic diagram of an electronic device according to an embodiment of the present disclosure.

### DETAILED DESCRIPTION

To make the objectives, technical solutions, and advantages of embodiments of the present disclosure clearer, the following clearly and completely describes the technical solutions in embodiments of the present disclosure with reference to the accompanying drawings in embodiments of the present disclosure. Apparently, the described embodiments are merely some rather than all of the embodiments of the present disclosure. The components in embodiments of the present disclosure described and shown in the accompanying drawings herein may be usually arranged and designed in a variety of different configurations. Therefore, the following detailed descriptions of embodiments of the present disclosure provided in the accompanying drawings are not intended to limit the scope of the present disclosure for which protection is claimed, but rather represents only selected embodiments of the present disclosure. Based on embodiments of the present disclosure, all other embodiments obtained by a person skilled in the art without creative efforts fall within the protection scope of the present disclosure.

It should be noted that similar reference numerals and letters indicate similar items in the following accompanying drawings, so that once an item is defined in one accompanying drawing, it does not need to be further defined and explained in subsequent accompanying drawings.

The term “and/or” in this specification describes only an association relationship, and indicates that three relationships may exist. For example, A and/or B may represent: Only A exists, both A and B exist, and only B exists. In addition, the term “at least one” in this specification indicates any one of a plurality or any combination of at least two of a plurality. For example, including at least one of A, B, and C may indicate including any one or more elements selected from a set consisting of A, B, and C.

It is found through research that, when a cloud service platform allocates computing resources to services, to ensure running statuses of computing nodes, cloud services are usually deployed on different computing nodes to the greatest extent, so that each computing node keeps a status with relatively low load.

However, when a relatively large quantity of cloud services need to be configured or when there is a relatively small quantity of computing nodes, because the cloud services are deployed in a relatively disperse manner, a large quantity of resource fragments may be generated on the computing nodes. These resource fragments are insufficient to independently deploy a new cloud service, resulting in waste of computing resources. Therefore, how to balance load of the computing nodes and the resource utilization in the process of deploying the cloud services has become an important problem affecting the effect of cloud services.

Based on the foregoing research, the present disclosure provides a cloud service deploying method. A target computing node group is determined from a plurality of available computing node groups, cloud service deployment is preferentially performed in the target computing node group, and then a standby computing node group is introduced when a deploying condition is not met, so as to effectively reduce resource fragments of computing nodes, thereby avoiding waste of computing resources. In addition, a target computing node with a highest quantity of available computing resources is selected from the target computing node group to deploy cloud services, to enable the cloud services to be disperse to the greatest extent in a range of the target computing node group, and prevent occurrence of a computing node with excessively high load, thereby ensuring normal running of the computing nodes.

For ease of understanding of this embodiment, a cloud service deploying method disclosed in an embodiment of the present disclosure is first described in detail. An execution body of the cloud service deploying method provided in this embodiment of the present disclosure is usually a computer device with a particular computing capability. The computer device includes, for example, a terminal device, a server, or another processing device. In some possible implementations, the cloud service deploying method may be implemented in a manner of invoking, by a processor, computer-readable instructions stored in a memory.

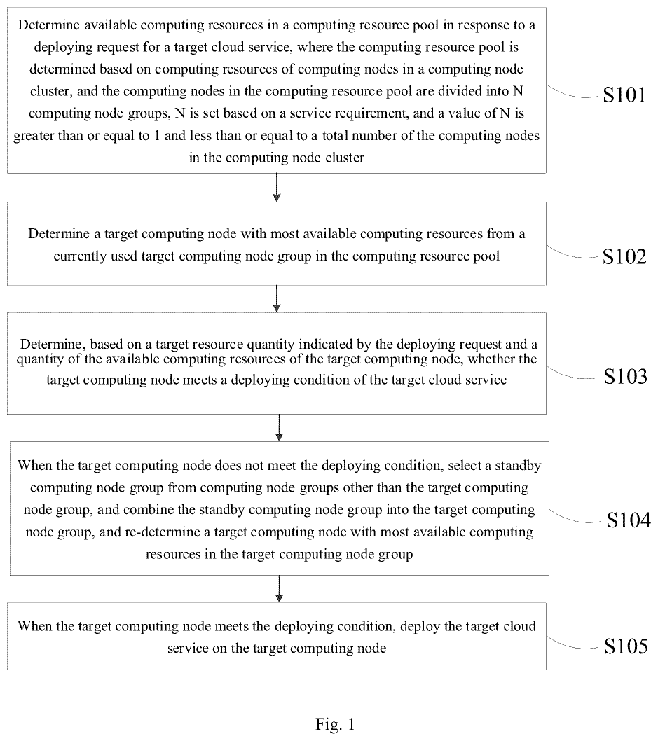

FIG. 1 is a flowchart of a cloud service deploying method according to an embodiment of the present disclosure. The method includes steps S101 to S105.

S101: Determine available computing resources in a computing resource pool in response to a deploying request for a target cloud service, where the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster.

The cloud service is based on add, use, and interactive modes of related services of the Internet, and usually relates to providing dynamic, easy-to-extend, and usually virtualized resources through the Internet. The cloud service means obtaining a required service in an on-demand and easy-to-extend manner through the network.

For example, the available computing resources in the computing resource pool may be divided by the following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

The attribute information of the available computing node may be common resource types owned by the computing node and corresponding holding amounts. For example, attribute information of a computing node may be “CPU (4) GPU (5) memory (8 G) network (100 Mb/s) magnetic disk (600 GB)”. The service requirement information may correspondingly include types of computing resources required by the to-be-deployed cloud service, for example, a central processing unit (central processing unit, CPU for short), a GPU, a memory, a network, a magnetic disk, and the like.

In a possible implementation, the value of the total number N of the computing node groups may be determined based on the total number of the plurality of available computing nodes, a first impact factor of running performance of the available computing nodes on the total number of the computing node groups, and a second impact factor of a resource utilization of the available computing nodes on the total number of the computing node groups. The first impact factor is a weight value preset according to a requirement of the service requirement for the running performance in a preset rule for determining N, and a smaller value of the first impact factor indicates better running performance. The second impact factor is a weight value preset according to a requirement of the service requirement for the resource utilization in the preset rule for determining N, and a larger value of the second impact factor indicates higher resource utilization. The values of the first impact factor and the second impact factor may change at any time according to a service scenario. Specifically, N may be determined based on a product of the total number of the available computing nodes, the first impact factor, and the second impact factor.

In a possible implementation, the value of the total number N of the computing node groups may alternatively be determined in the following manner:
determining, based on the service requirement information, a target type resource used as a division standard; and
dividing the plurality of available computing nodes into the N computing node groups based on a resource quantity that corresponds to the target type resource and that is indicated in the attribute information, so that the resource quantity of the target type resource in any one of the computing node groups is greater than or equal to a specified resource quantity.

After the attribute information of the available computing nodes and the service requirement information are obtained, a target computing resource type corresponding to the to-be-deployed service may be determined according to the obtained service requirement information, and then a holding amount corresponding to the target computing resource type is searched for in the attribute information of the available computing nodes, and the holding amount corresponding to the target computing resource type is used to divide the available computing nodes into groups, so that total holding amounts that correspond to the target computing resource type and that are in the N computing node groups obtained through division are similar, or the resource quantity of the target type resource in any one of the computing node groups is greater than or equal to the specified resource quantity.

After division into groups, other computing node groups other than the currently used target computing node group in the computing resource pool may be standby computing node groups.

S102: Determine a target computing node with most available computing resources from a currently used target computing node group in the computing resource pool.

For example, a currently used computing node group is the target computing node group, and a computing node with most computing resources is selected from the target computing node group as the target computing node.

For example, after the deploying request for the cloud service is received, a target resource quantity indicated by the deploying request may be determined, for example, five graphics processing units (Graphics Processing Unit, GPU). In this case, there are three computing nodes in the target computing node group, there are five available GPUs in a computing node 1, there are eight available GPUs in a computing node 2, and there are four available GPUs in a computing node 3. In this case, the computing node 2 with richest available GPU resources is selected as the target computing node.

S103: Determine, based on a target resource quantity indicated by the deploying request and a quantity of the available computing resources of the target computing node, whether the target computing node meets a deploying condition of the target cloud service.

The target resource may be software and hardware resources, middleware, application services, and the like that are used by a user, including a central processing unit (central processing unit, CPU for short), a GPU, a memory, a network, a magnetic disk, and the like.

Based on the feature, of immediate use after access, of cloud service resources, the user may request or release computing resources of the computing node according to a requirement, and therefore the quantity of the available computing resources of the target computing node fluctuates. When a system detects a relatively large-scale resource fluctuation, the quantity of the available computing resources of the target computing node needs to be updated in time.

When the quantity of the available computing resources of the target computing node is greater than or equal to the target resource quantity indicated by the deploying request, if the to-be-deployed cloud service can run normally when deployed on the target node, it is determined that the target computing node meets the deploying condition of the target cloud service; or when the quantity of the available computing resources of the target computing node is less than the target resource quantity indicated by the deploying request, if the to-be-deployed cloud service cannot run normally when deployed on the target node, it is determined that the target computing node does not meet the deploying condition of the target cloud service.

S104: When the target computing node does not meet the deploying condition, select a standby computing node group from computing node groups other than the target computing node group, and combine the standby computing node group into the target computing node group, and re-determine a target computing node with most available computing resources in the target computing node group.

For example, when the target computing node does not meet the deploying condition, a target standby computing node group that meets the deploying condition of the target cloud service may be determined from a plurality of standby computing node groups based on the target resource quantity indicated by the deploying request and available computing resource quantities of the standby computing node groups, and the target standby computing node group that meets the deploying condition of the target cloud service is added to the target computing node group.

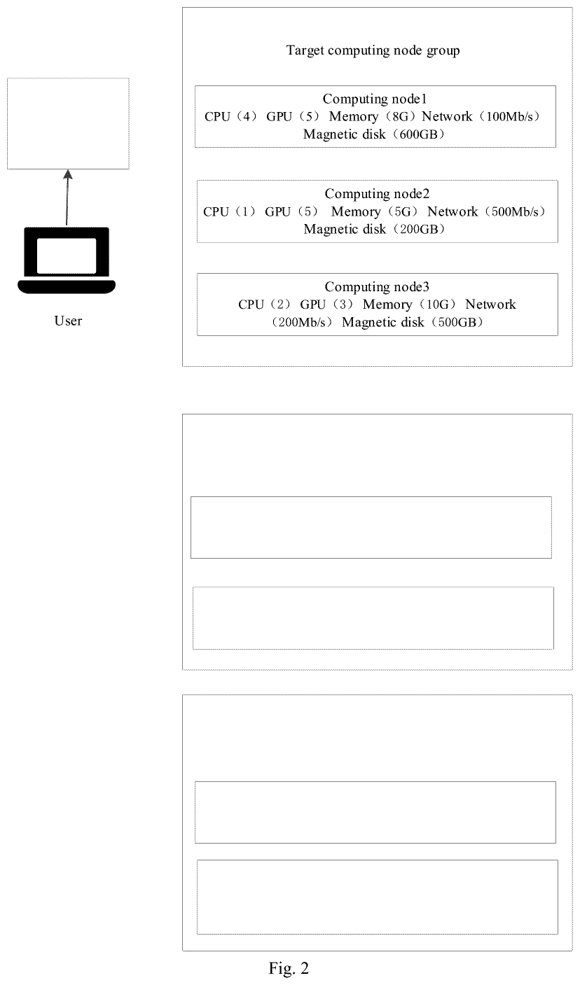

For example, FIG. 2 is a first schematic diagram of attribute information of available computing nodes according to an embodiment of the present disclosure. The attribute information shown in FIG. 2 is attribute information of the available computing nodes before the standby computing node group is added to the target computing node group. Computing node groups may include the target computing node group, a standby computing node group 1, and a standby computing node group 2. After the deploying request for the cloud service is received, the target resource quantity indicated by the deploying request may be determined, for example, five CPUs. The target computing node that includes most resources of a same type, namely, the computing node 1, may be determined in the target computing node group, and the computing node 1 has four CPUs, and does not meet the deploying condition. The standby computing node group 2 may be selected and added to the target computing node group.

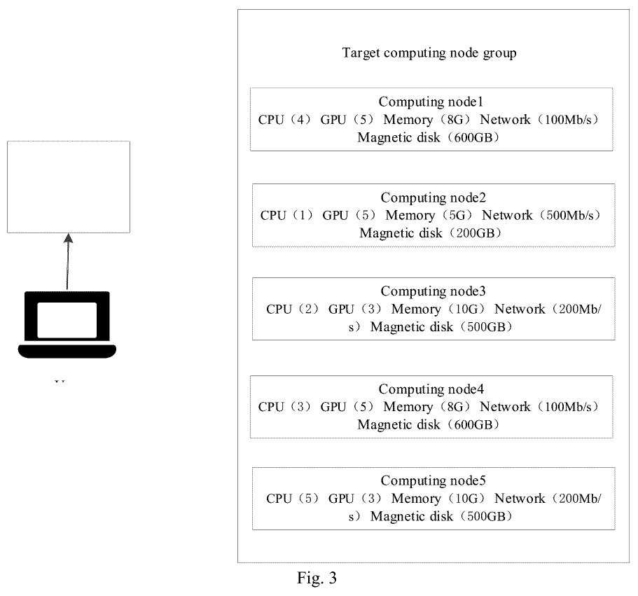

FIG. 3 is a second schematic diagram of attribute information of available computing nodes according to an embodiment of the present disclosure. The attribute information shown in FIG. 3 is attribute information of the available computing nodes after the standby computing node group is added to the target computing node group. The target computing node group includes five computing nodes, and the computing node that includes most resources of a same type is redetermined. The computing node 5 is the computing node that includes most CPU resources in the target computing node group.

S105: When the target computing node meets the deploying condition, deploy the target cloud service on the target computing node.

A target virtual machine is deployed on the target computing node, where available computing resources occupied by the target virtual machine match the target resource quantity, and the target cloud service is deployed on the target virtual machine.

A virtual machine is a complete computer system that has complete hardware system functions and that runs in a completely isolated environment through software simulation. Work that can be completed in a physical computer can be implemented in a virtual machine. When a virtual machine is created in a computer, a part of hard disk and memory capacity of the physical computer needs to be used as hard disk and memory capacity of the virtual machine. After an independent virtual machine is deployed for the target cloud service, a closed running environment can be provided for the target cloud service, security is higher, and management is facilitated.

According to the cloud service deploying method and apparatus, the electronic device, and the storage medium that are provided in embodiments of the present disclosure, first, the available computing resources in the computing resource pool are determined in response to the deploying request for the target cloud service, where the computing resource pool is determined based on the computing resources of the computing nodes in the computing node cluster, and the computing nodes in the computing resource pool are divided into the N computing node groups, Nis set based on the service requirement, and the value of N is greater than or equal to 1 and less than or equal to the total number of the computing nodes in the computing node cluster; then the target computing node with the most available computing resources is determined from the currently used target computing node group in the computing resource pool; and then, based on the target resource quantity indicated by the deploying request and the quantity of the available computing resources of the target computing node, whether the target computing node meets the deploying condition of the target cloud service is determined; when the target computing node does not meet the deploying condition, the standby computing node group is selected from computing node groups other than the target computing node group, and the standby computing node group is combined into the target computing node group, and the target computing node with the most available computing resources in the target computing node group is redetermined; or if the target computing node meets the deploying condition, the target cloud service is deployed on the target computing node. In the implementations of the present disclosure, the target computing node group is determined from the plurality of available computing node groups, cloud service deployment is preferentially performed in the target computing node group, and then the standby computing node group is introduced when the deploying condition is not met, so as to effectively reduce the resource fragments of the computing nodes, thereby avoiding waste of the computing resources. In addition, the target computing node with the highest quantity of available computing resources is selected from the target computing node group to deploy the cloud services, to enable the cloud services to be disperse to the greatest extent in the range of the target computing node group, and prevent occurrence of the computing node with excessively high load, thereby ensuring normal running of the computing nodes.

A person skilled in the art may understand that, in the foregoing methods of specific implementations, the order in which the steps are written does not means a strict order of execution, and does not constitute any limitation on the implementation process, and the specific order of execution of the steps should be determined by functions and possible internal logic of the steps.

Based on a same inventive concept, an embodiment of the present disclosure further provides a cloud service deploying apparatus corresponding to the cloud service deploying method. Because the apparatus in this embodiment of the present disclosure resolves the problem in a principle similar to that of the foregoing cloud service deploying method in embodiments of the present disclosure, for the implementation of the apparatus, reference may be made to the implementation of the method, and details are not described again.

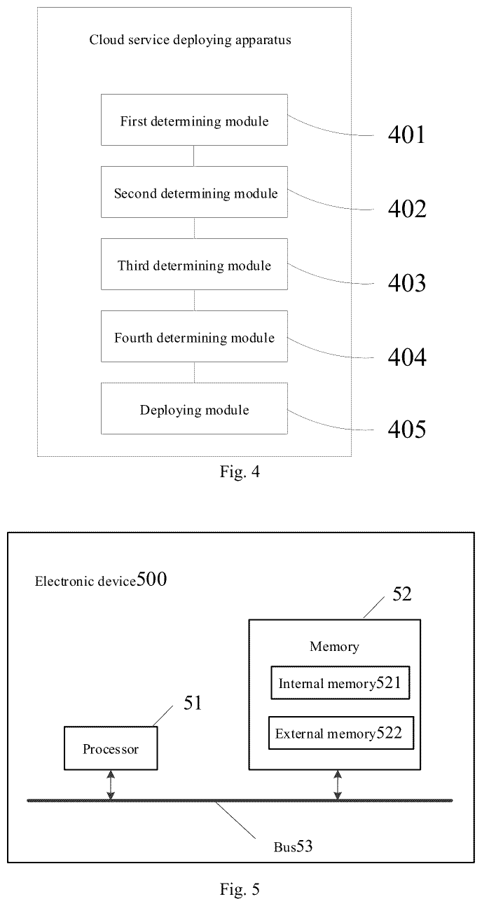

FIG. 4 is a schematic diagram of deploying cloud service provided by an embodiment of the present disclosure, the apparatus includes a first determining module 401, a second determining module 402, a third determining module 403, a fourth determining module 404 and a deploying module 405,
the first determining module 401 is configured to determine available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
the second determining module 402 is configured to determine a target computing node with most available computing resources from a currently used target computing node group in the computing resource pool;
the third determining module 403 is configured to determine, based on a target resource quantity indicated by the deploying request and a quantity of the available computing resources of the target computing node, whether the target computing node meets a deploying condition of the target cloud service;
the fourth determining module 404 is configured to, when the target computing node does not meet the deploying condition, select a standby computing node group from computing node groups other than the target computing node group, and combine the standby computing node group into the target computing node group, and re-determine a target computing node with most available computing resources in the target computing node group; and
the deploying module 405 is configured to, when the target computing node meets the deploying condition, deploy the target cloud service on the target computing node.

In an optional implementation, when dividing the available computing resources in the computing resource pool, the first determining module is used for:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

In an optional implementation, when dividing the plurality of available computing nodes into the N computing node groups based on the attribute information and the service requirement information, the first determining module is used for:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

In an optional implementation, when dividing the plurality of available computing nodes into the N computing node groups based on the attribute information and the service requirement information, the first determining module is used for:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

In an optional implementation, when determining, based on a target resource quantity indicated by the deploying request and a quantity of the available computing resources of the target computing node, whether the target computing node meets a deploying condition of the target cloud service, the third determining module is used for:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

In an optional implementation, when selecting a standby computing node group from computing node groups other than the target computing node group, and combining the standby computing node group into the target computing node group, the fourth determining module is used for:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.

In an optional implementation, when deploying the target cloud service on the target computing node, the deploying module is used for:
deploying a target virtual machine on the target computing node, wherein available computing resources occupied by the target virtual machine match the target resource quantity; and
deploying the target cloud service on the target virtual machine.

Reference may be made to related descriptions in the foregoing method embodiment for descriptions of processing procedures of the modules in the apparatus, and procedures of interactions between the modules.

Corresponding to the cloud service deploying method in FIG. 1, an embodiment of the present disclosure further provides an electronic device 500. FIG. 5 is a schematic structural diagram of an electronic device 500 according to an embodiment of the present disclosure. The electronic device 500 includes:
a processor 51, a memory 52, and a bus 53. The memory 52 is configured to store an execution instruction, and includes an internal memory 521 and an external memory 522. The internal memory 521 herein is also referred to as an internal storage, and is configured to temporarily store operational data in the processor 51, and data exchanged with the external memory 522 such as a hard disk. The processor 51 exchanges data with the external memory 522 by using the internal memory 521. When the electronic device 500 runs, the processor 51 communicates with the memory 52 through the bus 53, so that the processor 51 executes the following instruction:
determining available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
determining a target computing node with most available computing resources from a currently used target computing node group in the computing resource pool;
determining, based on a target resource quantity indicated by the deploying request and a quantity of the available computing resources of the target computing node, whether the target computing node meets a deploying condition of the target cloud service;
when the target computing node does not meet the deploying condition, selecting a standby computing node group from computing node groups other than the target computing node group, and combining the standby computing node group into the target computing node group, and re-determining a target computing node with most available computing resources in the target computing node group; and
when the target computing node meets the deploying condition, deploying the target cloud service on the target computing node.

In an optional implementation, among the instructions executed by the processor 51, the available computing resources in the computing resource pool are divided by the following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

In an optional implementation, among the instructions executed by the processor 51, the dividing the plurality of available computing nodes into the N computing node groups based on the attribute information and the service requirement information includes:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

In an optional implementation, among the instructions executed by the processor 51, the dividing the plurality of available computing nodes into the N computing node groups based on the attribute information and the service requirement information includes:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

In an optional implementation, among the instructions executed by the processor 51, the determining, based on a target resource quantity indicated by the deploying request and a quantity of the available computing resources of the target computing node, whether the target computing node meets a deploying condition of the target cloud service includes:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

In an optional implementation, among the instructions executed by the processor 51, the selecting a standby computing node group from computing node groups other than the target computing node group, and combining the standby computing node group into the target computing node group includes:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.

In an optional implementation, among the instructions executed by the processor 51, the deploying the target cloud service on the target computing node includes:
deploying a target virtual machine on the target computing node, wherein available computing resources occupied by the target virtual machine match the target resource quantity; and
deploying the target cloud service on the target virtual machine.

An embodiment of the present disclosure further provides a computer-readable storage medium, where the computer-readable storage medium stores a computer program, and when the computer program is run by a processor, the steps of the cloud service deploying method in the forgoing method embodiment are performed. The storage medium may be a volatile or non-volatile computer-readable storage medium.

An embodiment of the present disclosure further provides a computer program product. The computer program product carries program code. Instructions included in the program code may be used to perform the steps of the cloud service deploying method in the foregoing method embodiment. Reference may be made to the foregoing method embodiment for details. Details are not described herein again.

The computer program product may be realized specifically by means of hardware, software or a combination thereof. In an optional embodiment, the computer program product is specifically embodied as a computer storage medium, and in another optional embodiment, the computer program product is specifically embodied as a software product, such as a software development kit (Software Development Kit, SDK) or the like.

It may be clearly understood by a person skilled in the art that, for the purpose of convenient and brief description, for a detailed working process of the system and apparatus described above, reference may be made to a corresponding process in the foregoing method embodiments. Details are not described herein again. In several embodiments provided in the present disclosure, it should be understood that the disclosed system, apparatus, and method may be implemented in another manner. The apparatus embodiments described above are merely examples. For example, division into the units is merely logic function division and may be other division in actual implementation. For another example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, each of the units may exist alone physically, or two or more units are integrated into one unit.

When the functions are implemented in the form of a software functional unit and sold or used as an independent product, the functions may be stored in a nonvolatile computer-readable storage medium that can be executed by a processor. Based on such an understanding, the technical solutions of the present disclosure essentially, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of the present disclosure. The foregoing storage medium includes: any medium that can store program code, for example, a USB flash drive, a removable hard disk, a read-only memory (Read-Only Memory, ROM), a random access memory (Random Access Memory, RAM), a magnetic disk, or an optical disc.

Finally, it should be noted that the foregoing embodiments are merely specific implementations of the present disclosure, and are used to describe the technical solutions of the present disclosure, but not to limit the technical solutions of the present disclosure, and the protection scope of the present disclosure is not limited thereto. Although the present disclosure has been described in detail with reference to the foregoing embodiments, a person of ordinary skill in the art should understand that any person skilled in the art can still modify the technical solutions recorded in the foregoing embodiments, easily figure out changes, or equivalently replace some of the technical features therein within the technical scope disclosed in the present disclosure. However, these modifications, changes, or replacements do not make the essence of the corresponding technical solutions depart from the spirit and scope of the technical solutions of embodiments of the present disclosure, and should all be covered within the protection scope of the present disclosure. Therefore, the protection scope of the present disclosure shall be subject to the protection scope of the claims.

1. A method for deploying cloud service, comprising:
determining available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
determining a target computing node with most available computing resources from a currently used target computing node group in the computing resource pool;
determining, based on a target resource quantity indicated by the deploying request and a quantity of the available computing resources of the target computing node, whether the target computing node meets a deploying condition of the target cloud service;
when the target computing node does not meet the deploying condition, selecting a standby computing node group from computing node groups other than the target computing node group, and combining the standby computing node group into the target computing node group, and re-determining a target computing node with most available computing resources in the target computing node group; and
when the target computing node meets the deploying condition, deploying the target cloud service on the target computing node.

2. The method according to claim 1, wherein the available computing resources in the computing resource pool are divided by following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

3. The method according to claim 2, wherein the dividing the plurality of available computing nodes into the N computing node groups based on the attribute information and the service requirement information comprises:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

4. The method according to claim 2, wherein the dividing the plurality of available computing nodes into the N computing node groups based on the attribute information and the service requirement information comprises:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

5. The method according to claim 1, wherein the determining, based on a target resource quantity indicated by the deploying request and a quantity of the available computing resources of the target computing node, whether the target computing node meets a deploying condition of the target cloud service comprises:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

6. The method according to claim 1, wherein the selecting a standby computing node group from computing node groups other than the target computing node group, and combining the standby computing node group into the target computing node group comprises:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.

7. The method according to claim 1, wherein the deploying the target cloud service on the target computing node comprises:
deploying a target virtual machine on the target computing node, wherein available computing resources occupied by the target virtual machine match the target resource quantity; and
deploying the target cloud service on the target virtual machine.

8. (canceled)

9. An electronic device, comprising: a processor, a memory, and a bus, wherein the memory stores machine-readable instructions executable by the processor, and when the electronic device runs, the processor communicates with the memory via the bus, and when the machine-readable instructions are executed by the processor, a method for deploying cloud service is performed, the method comprises:
determining available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
determining a target computing node with most available computing resources from a currently used target computing node group in the computing resource pool;
determining, based on a target resource quantity indicated by the deploying request and a quantity of the available computing resources of the target computing node, whether the target computing node meets a deploying condition of the target cloud service;
when the target computing node does not meet the deploying condition, selecting a standby computing node group from computing node groups other than the target computing node group, and combining the standby computing node group into the target computing node group, and re-determining a target computing node with most available computing resources in the target computing node group; and
when the target computing node meets the deploying condition, deploying the target cloud service on the target computing node.

10. A non-transitory computer-readable storage medium, wherein the computer-readable storage medium stores a computer program, and when the computer program is executed by a processor, a method for deploying cloud service is performed, the method comprises:
determining available computing resources in a computing resource pool in response to a deploying request for a target cloud service, wherein the computing resource pool is determined based on computing resources of computing nodes in a computing node cluster, and the computing nodes in the computing resource pool are divided into N computing node groups, N is set based on a service requirement, and a value of N is greater than or equal to 1 and less than or equal to a total number of the computing nodes in the computing node cluster;
determining a target computing node with most available computing resources from a currently used target computing node group in the computing resource pool;
determining, based on a target resource quantity indicated by the deploying request and a quantity of the available computing resources of the target computing node, whether the target computing node meets a deploying condition of the target cloud service;
when the target computing node does not meet the deploying condition, selecting a standby computing node group from computing node groups other than the target computing node group, and combining the standby computing node group into the target computing node group, and re-determining a target computing node with most available computing resources in the target computing node group; and
when the target computing node meets the deploying condition, deploying the target cloud service on the target computing node.

11. The electronic device according to claim 9, wherein the available computing resources in the computing resource pool are divided by following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

12. The electronic device according to claim 11, wherein the dividing the plurality of available computing nodes into the N computing node groups based on the attribute information and the service requirement information comprises:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

13. The electronic device according to claim 11, wherein the dividing the plurality of available computing nodes into the N computing node groups based on the attribute information and the service requirement information comprises:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

14. The electronic device according to claim 9, wherein the determining, based on a target resource quantity indicated by the deploying request and a quantity of the available computing resources of the target computing node, whether the target computing node meets a deploying condition of the target cloud service comprises:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

15. The electronic device according to claim 9, wherein the selecting a standby computing node group from computing node groups other than the target computing node group, and combining the standby computing node group into the target computing node group comprises:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.

16. The electronic device according to claim 9, wherein the deploying the target cloud service on the target computing node comprises:
deploying a target virtual machine on the target computing node, wherein available computing resources occupied by the target virtual machine match the target resource quantity; and
deploying the target cloud service on the target virtual machine.

17. The non-transitory computer-readable storage medium according to claim 10, wherein the available computing resources in the computing resource pool are divided by following steps:
obtaining attribute information of a plurality of available computing nodes, and service requirement information; and
dividing the plurality of available computing nodes into the N computing node groups based on the attribute information and the service requirement information, and selecting one computing node group from the plurality of computing node groups as the target computing node group.

18. The non-transitory computer-readable storage medium according to claim 17, wherein the dividing the plurality of available computing nodes into the N computing node groups based on the attribute information and the service requirement information comprises:
determining the value of N based on the total number of the plurality of available computing nodes, a first impact factor of running performance of the available computing nodes on a total number of the computing node groups, and a second impact factor of a resource utilization of the available computing nodes on the total number of the computing node groups; and
dividing the plurality of available computing nodes into the N computing node groups based on the attribute information, the service requirement information, and a determined total number of the computing node groups.

19. The non-transitory computer-readable storage medium according to claim 17, wherein the dividing the plurality of available computing nodes into the N computing node groups based on the attribute information and the service requirement information comprises:
determining, based on the service requirement information, a target type resource used as a division standard; and
dividing the plurality of available computing nodes into the N computing node groups based on a resource quantity that corresponds to the target type resource and that is indicated in the attribute information, so that a resource quantity of the target type resource in any one of the computing node groups is greater than or equal to a specified resource quantity.

20. The non-transitory computer-readable storage medium according to claim 10, wherein the determining, based on a target resource quantity indicated by the deploying request and a quantity of the available computing resources of the target computing node, whether the target computing node meets a deploying condition of the target cloud service comprises:
when the quantity of the available computing resources of the target computing node is greater than or equal to the target resource quantity indicated by the deploying request, determining that the target computing node meets the deploying condition of the target cloud service;
when the quantity of the available computing resources of the target computing node is less than the target resource quantity indicated by the deploying request, determining that the target computing node does not meet the deploying condition of the target cloud service.

21. The non-transitory computer-readable storage medium according to claim 10, wherein the selecting a standby computing node group from computing node groups other than the target computing node group, and combining the standby computing node group into the target computing node group comprises:
determining a target standby computing node group from a plurality of standby computing node groups based on the target resource quantity indicated by the deploying request and a quantity of available computing resources of the standby computing node groups; and
combining a standby computing node in the target standby computing node group into the target computing node group.
